(19) United States
(12) Patent Application Publication
(10) Pub. No.: US 2017/0327218 A1
(43) Pub. Date: Nov. 16, 2017

(54) LIGHT UNMANNED VERTICAL TAKE-OFF AIRCRAFT

(71) Applicants: Universite Pierre et Marie Curie (UPMC), Paris (FR); Centre National de la Recherche Scientifique, Paris (FR)

(72) Inventors: Pascal Morin, Reuil Malmaison (FR); Olivier Gaste, Sevran (FR); Duckien Phung, Vitry Sur Seine (FR)

(21) Appl. No.: 15/535,309

(22) PCT Filed: Dec. 11, 2015
(86) PCT No.: PCT/EP2015/079497

§ 371 Date: Jun. 12, 2017

(30) Foreign Application Priority Data
Dec. 12, 2014 (FR) 1462384

(51) Int. Cl. B64C 29/00; B64C 3/38; B64C 39/02; B64C 13/28; B64C 27/26

(52) U.S. Cl. CPC B64C 29/0025; B64C 13/28; B64C 27/26; B64C 39/024; B64C 3/385; B64C 2201/104; B64C 2201/108; B64C 2201/165; B64C 2201/088

(57) ABSTRACT

A light unmanned vertical take-off aircraft includes at least two fixed coplanar propulsion devices and at least one wing providing the lift for the drone. The coplanar propulsion devices and the wing are each laid out on the frame of the drone so that the plane of the profile chord line of the wing is substantially parallel to the plane defined by the two coplanar propulsion devices. The wing is pivotingly mobile relative to the frame along an axis parallel to the pitch axis of the drone. Also a method is provided for controlling orientation of a wing of a light unmanned vertical take-off aircraft as described here above. The method includes controlling an orientation of a wing as a function of at least one flight parameter of the aircraft.

### 1. FIELD OF THE INVENTION

The disclosure pertains to light unmanned vertical take-off aircraft, commonly called drones. More specifically, the disclosure relates to what are called “convertible” drones adapted to efficient stationary flight (or hovering) as well as fast flight between two destinations.

The disclosure relates especially to a convertible drone which, through its uncomplicated structure, combines satisfactory energy autonomy with satisfactory maneuverability or handling ease.

### 2. PRIOR ART

Vertical take-off and landing drones, especially quadrotor drones, have become omnipresent in the world of mini-drones. Their main value lies in the great simplicity of their design, as compared with the helicopter-type structure that has long prevailed in this field. These drones however have the drawback of low energy autonomy, especially because of their low lift in fast flight, as compared with fixed-wing aircraft.

At the same time, in the field of manned aircraft, there is research aimed at making vertical take-off craft vertical “convertible” by increasing their lift in fast flight through the addition of one or more wings. In this respect, certain aircraft known as “tail-sitter” aircraft take off vertically, tilt towards the horizontal in the fast flight phase and then return to the vertical position for landing. However, the tilting of the aircraft during the transition between stationary flight and fast flight (known as the phase transition here below in the text) tends to unbalance the aircraft and to make it more difficult to maneuver.

Other “tilt-rotor” type convertible craft comprise wings that are rigidly connected to their frame and are equipped at their extremities with a rotor capable of pivoting about the axis of the wing. During the take-off phase, the rotor is oriented to the vertical, upwards. During the phase transition, the rotor pivots by 90 degrees so as to get oriented towards the front of the aircraft, as in an aircraft. The lift then exerted by the wings in fast flight reduces the energy consumption of the tilt-rotor type craft. These tilt-rotor type craft however have many drawbacks. First, the propulsion system of a tilt-rotor is technically more complicated to implement than that of a traditional rotating-wing drone, given the addition of the wings and especially the use of rotating mechanisms for the rotors at the extremities of each of these wings. The addition of these elements contributes especially to increasing the total mass of the tilt-rotor type craft and therefore its energy consumption. Second, the wing of the tilt-rotor type craft, horizontally oriented in the take-off phase, is situated in the slipstream of the rotor. A part of the thrust force exerted by the rotor is therefore dissipated by interference with the wing, further aggravating the energy balance of the tilt-rotor. Third, the rapid, large-scale variations of the aerodynamic forces acting on the structure of the drone during the phase transition makes the tilt-rotor type craft more unstable and therefore more difficult to control. Finally, it must be noted that the wings of the tilt-rotor are rigidly connected to its frame. Consequently, a change in the angle of attack of the wings is possible only through re-orientation of the entire device. Such a layout therefore limits the maneuverability or handling ease of the tilt-rotor type craft and more specifically its capacity to adopt, easily and independently of the orientation of its frame, a configuration that maximizes the flight envelope (including the lift) of its wings and thus minimizes its energy consumption.

Another type of convertible craft, called a tilt-wing craft, implements wings orientable relative to its frame. The propulsion rotors are rigidly connected to each of the wings of the tilt-wing craft and it is therefore the rigid assembly formed by the wings and the rotors that pivots relative to its frame. Although the tilt-wing makes it possible to cope with certain difficulties caused by tilt-rotors, by limiting pivot-type hinges at the junction between the frame and the wings, and by reducing the apparent surface area of the wings in the slipstream of the rotors in the take-off phase, the tilt-wing nevertheless has numerous and major technical drawbacks. First, the big angle of attack of the wings during the phase transition can cause the tilt-wing type craft to stall, thus significantly reducing its stability. Secondly, the tilt-wing craft can be particularly difficult to maneuver in the take-off phase, given the high wind drag of its wings. Finally, the rigid attachment of the rotors of the tilt-wing structure to its wings reduces its maneuverability and more specifically its capacity to adopt a configuration, easily and independently of the orientation of the rotors (and of the orientation of the thrust force that results therefrom), enabling it to maximize the flight envelope of its wings and therefore minimize its energy consumption.

Given the numerous technical drawbacks inherent in the use of tilt-rotor and tilt-wing type craft, such as their high energy consumption, their technical complexity, their instability in stationary flight and/or during their phase transition, and their limited maneuverability, it is an unquestionable fact that one skilled in the art seeking to increase the energy autonomy and maneuverability of a rotating-wing drone while at the same time mitigating the above-mentioned technical drawbacks, would not have been encouraged to draw inspiration from these particular types of convertible manned craft. The reason for this is that, firstly, these craft have to overcome many technical difficulties and, secondly, they have problems of implementation generally far removed from those of the mini-drones (of which the weight, range and energy source are characteristics remote from the weight, range and energy source of a manned craft).

### 3. SUMMARY

The technique proposed does not have these drawbacks of the prior art. More particularly, in at least one embodiment, the proposed technique relates to a light unmanned vertical take-off aircraft comprising at least two fixed coplanar propulsion devices and at least one wing providing the aircraft with its lift. The coplanar propulsion devices and the wing are each laid out on the frame of the aircraft such that the plane of the wing profile chord line is substantially parallel to the plane defined by the two coplanar propulsion devices. This craft is characterized in that the wing is pivotingly mobile relative to the frame along an axis parallel to the pitch axis of the aircraft.

The term “fixed” as used in the present description qualifies a complete mechanical link that leaves no degree of liberty whatsoever. The term “frame” designates the assembly formed by the structural elements of the aircraft. The expression “profile chord line” designates the line between the center of curvature of the leading edge of the wing and that of its trailing edge.

The presence of one or more pivoting wings thus enables the aircraft to reduce its energy consumption while increasing its autonomy and makes it possible to achieve this result without impairing its vertical take-off and landing capacities. Indeed, such an aircraft can adopt a configuration, easily and independently of the orientation of its propulsion devices (and the orientation of the thrust force that results therefrom), that enables its wings to benefit from the lift that can be offered by an airflow present during the different phases of take-off, flight and landing of the craft.

The independent pivoting of the wing of the craft also has the advantage of enabling the craft to adopt configurations showing satisfactory flight stability, in minimizing for example, the wind drag of the wing during the vertical flight phases. The rapid variations in the lift of the wing, generated by these changes in tilt, also have a direct influence on the motions of the craft and therefore increase the maneuverability of the aircraft.

Such a craft also has the advantage of limited technical complexity which makes it easier to produce, use and maintain.

According to one particular characteristic, at least one wing of the craft is positioned outside the area of air backflow from the propulsion devices.

This particular arrangement of the wing avoids disturbing the air flow needed for the mobility of the aircraft, and thus optimises the effective thrust force of the propulsion devices.

According to one particular characteristic, the aircraft has four coplanar propulsion devices.

Such an aircraft has the advantages of satisfactory propulsion power, stability and maneuverability.

According to one particular characteristic, at least one coplanar propulsion device takes the form of a rotor and an airfoil surface in rotation around the axis of the rotor.

Such a propulsion device has low technical complexity while enabling the reversal of the sense of rotation of the airfoil surface. Such a reversal of the sense of rotation is especially implemented for the control of the quadrotor.

According to one particular characteristic, at least one wing is mobile between at least two positions:
a position in which the lift of the wing has no influence on the flight dynamics of the aircraft;
a position in which the lift of the wing influences the flights dynamics of the aircraft.

This characteristic makes it possible to adapt the orientation of the wing so as to optimize its lift and/or its other mechanical properties (its air penetration for example).

According to one particular characteristic, the orientation of at least one wing relative to the frame is a function of at least one flight parameter of the aircraft.

The orientation of the wing can therefore be adapted independently (without action by a user) to flight conditions and to the flying speed of the craft. The flight parameters of the craft include the flight speed of the drone and the tilt of the wing. The term “tilt of the wing” designates the angular difference between the chord line of the wing and the roll axis of the aircraft.

According to one particular characteristic, the aircraft comprises a device for measuring the air speed at the aircraft.

Such a device for measuring the air speed of the aircraft can, for example, include a wind speed indicator and/or a pitot tube.

According to one particular characteristic, the aircraft comprises an actuator capable of applying a control torque to the aircraft. The sense of this torque is opposite that of the torque generated by the aerodynamic forces.

Such an actuator has the advantage of making the tilt of the wing vary passively, i.e. without requiring the use of a device for measuring the speed of the craft.

According to one particular characteristic, the aircraft comprises at least two wings.

According to one particular characteristic, the wings are laid out symmetrically on the frame, on either side of a plane parallel to the pitch axis, said plane including the center of gravity of the aircraft.

Such a symmetrical layout of the wings gives rise to high pitch torque values and improves the stability of the craft in stationary flight. Moreover, the addition of the wings does not shift the center of gravity of the frame of the craft. Repositioning of its payload is therefore not necessary. Such wings can therefore be easily adapted to the quadrotor structure which originally has no wings.

According to one particular characteristic, the travel of the wings about their pivoting axis is symmetrical to the vertical.

This characteristic enables the craft to directly reverse its sense of shift without having to make a 180° yaw rotation.

According to one particular characteristic, at least one wing comprises a plurality of parts pivotingly movable relative to one another with an axis parallel to the pitch axis of the aircraft.

The fact that these different parts of the same wing are not fixedly coupled to each other substantially improves the maneuverability of the drone and especially its roll capacity.

According to one particular characteristic, at least one wing is positioned detachably on the frame.

This characteristic makes the structure easily upgradeable. It is thus possible to replace the wings initially positioned on the frame by different wings (in terms of profile or chord line for example) without any impact on the rest of the structure, given that the different types of wings will be varyingly adapted to flight conditions, flight speed and onboard payload.

The proposed technique also relates to a method for controlling the orientation of wing of the aircraft, characterized in that it comprises at least one step for controlling an orientation of a wing as a function of at least one flight parameter of the aircraft.

According to one particular characteristic, this method for controlling comprises a step for measuring the air speed and/or the ground speed of the aircraft.

According to one particular characteristic, this control method comprises a step for implementing a recoil spring type controller with variable gain.

This characteristic has the advantage of enabling the tilt of the wing to be varied passively, i.e. without necessitating a step for measuring the speed of the craft.

### 4. FIGURES

Other features and advantages shall appear more clearly from the following description of a particular embodiment of the disclosure, given by way of a simple illustratory and non-exhaustive example and from the appended drawings, of which:

FIG. 1 is an illustration, in a perspective or three-quarter view, of a drone according to one particular embodiment of the disclosure;

FIG. 2 is an illustration, in a view along a section A-A, of the front portion along section B-B of a drone according to one particular embodiment of the disclosure;

FIG. 3 is an illustration, in a profile view, of a drone wing according to one particular embodiment of the disclosure;

FIG. 4 is an illustration, in a profile view, of a drone wing according to one particular embodiment of the disclosure;

FIG. 5 is a chart illustrating the successive steps implemented during the conduct of a method for controlling a drone according to one particular embodiment of the disclosure;

FIG. 6 is a chart illustrating the successive steps implemented during the conduct of a method for controlling a drone according to one particular embodiment of the disclosure;

FIG. 7 is an illustration, in a profile view, of a drone according to one particular embodiment of the disclosure;

FIG. 8 illustrates the principle of equilibrium between the aerodynamic moment and the gravitational moment implemented according to the present technique;

FIG. 9 presents the principle of modification of the angle of attack by the shifting of a mass as proposed in the present disclosure;

FIG. 10 presents a particular mode of actuation of the moving mass according to the present disclosure.

The different elements illustrated in the figure are not necessarily drawn to true scale, the focus being rather on the representation of the general functioning of the disclosure.

### 5. DESCRIPTION

### 5.1. General Principle

The proposed technique relates to a light unmanned vertical take-off and convertible aircraft comprising at least two coplanar propulsion devices rigidly connected to its frame. The frame (or body) of this craft, called a “tilt-body” type frame, is oriented along the horizontal plane when the craft is in stationary flight and in a plane that is varyingly tilted (variation of the attitude of the craft) when the craft is in the fast flight phase. It is therefore the orientation of the assembly formed by the frame of the craft and its propulsion devices that varies during the phase transition of the craft.

Such a craft also comprises at least one wing providing its lift and therefore reducing the energy consumption of the craft in fast flight. This wing is pivotingly mobile relative to the frame along an axis parallel to the pitch axis of the drone. Such a pivoting of the wing, independently of the frame and of the propulsion devices, especially enables the craft to easily adopt a configuration that allows it to optimize the lift from its wings and thus minimize energy consumption. Such a craft therefore has satisfactory energy autonomy and maneuverability

In general, this disclosure thus relates to a light unmanned vertical take-off aircraft comprising at least two fixed coplanar propulsion devices and at least one wing providing the drone with its lift. The coplanar propulsion devices and the wing are each arranged on the frame of the drone so that the plane of the wing profile chord line is substantially parallel to the plane defined by the two coplanar propulsion devices. The wing is pivotingly mobile relative to the frame along an axis parallel to the pitch axis of the craft.

The disclosure also relates to a method for controlling such a craft comprising a step for controlling the orientation of the wing, which implements at least one flight parameter of the drone.

The craft for example takes the form of a drone equipped with four coplanar rotors (quadrotor structure) comprising two detachable wings laid out symmetrically with respect to each other in the front and rear of the drone. The orientation of these wings depends on at least one flight parameter of the drone and is mobile between at least two positions in which the profile chord line planes of these wings are respectively oriented along the vertical and horizontal axes. Besides, one of the wings can comprise a plurality of mobile parts, mobile relative to each other, pivoting about an axis parallel to the pitch axis of the drone.

Whatever the embodiments, the proposed craft has the advantage of reducing energy consumption while at the same time augmenting its independence, in achieving this goal without impairing its vertical take-off and landing capacities. Indeed, the presence of one or more pivoting wings situated beyond the air blowback area created by the propulsion devices makes it possible firstly to avoid disturbing the airflow needed for the mobility of the craft and secondly, to benefit, if necessary, from the lift that can be offered by the ambient airflow, for example that of an air current naturally present during the different phases of take-off, flight or landing of the craft.

Here below, a particular embodiment is presented of a convertible, light unmanned vertical take-off aircraft. It is understood that the scope of the present invention is in no way restricted by this particular embodiment and that it is perfectly possible to implement other embodiments.

### 5.2. Description of the Structure of a Drone According to One Particular Embodiment of the Disclosure.

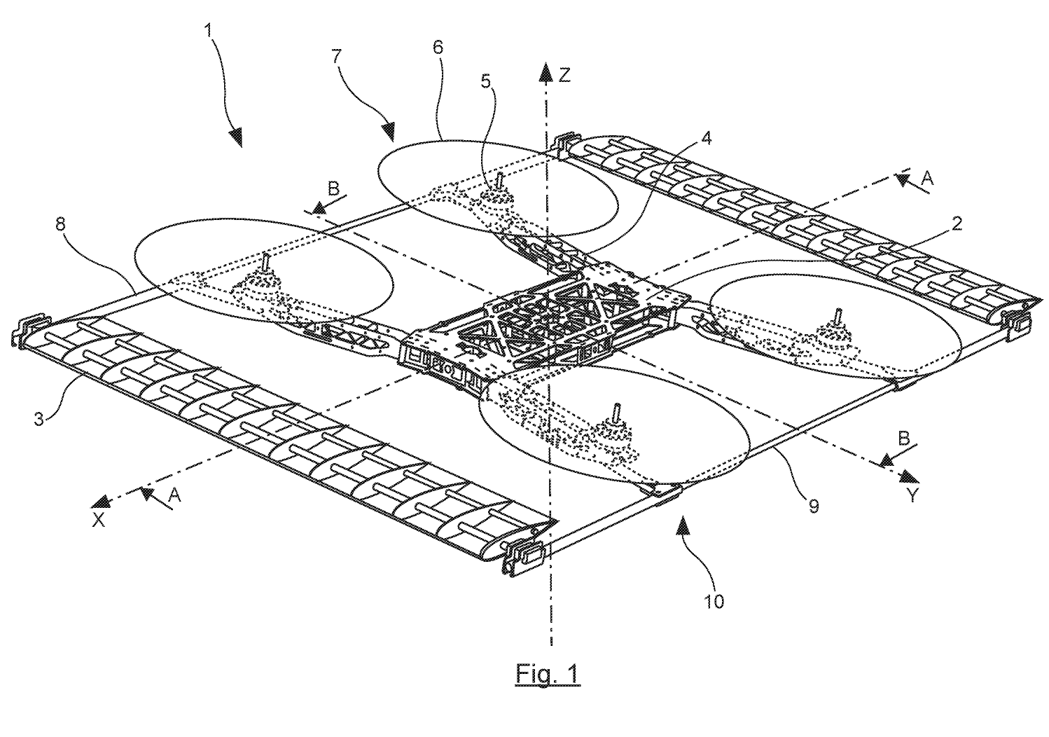

FIG. 1 gives a view in perspective of a light unmanned aircraft or drone (1). The entire structure is laid out about a hull (2) of the drone and more specifically about the center of gravity (G) of the drone located at the center of this hull (2). For reasons of clarity, the following description in its entirety takes as its reference a direct referential system (G; X; Y; Z) related to the frame (10) of the drone and having a center of gravity (G) as its center. The axis Z corresponds to the yaw axis of the drone (1). This axis Z is appreciably perpendicular to the ground when the drone (1) is in stationary flight. Z is taken to extend from the lower part (bottom) towards the upper part (top) of the drone (1). The axis X corresponds to the roll axis of the drone (1) and extends from the rear to the front of the drone (1). The axis Y corresponds to the pitch axis of the drone (1) and extends from the left to the right of the drone (1). All the constituent elements of the drone (1), except for the wings (3), are governed by a dual symmetry, relative to the two planes respectively formed by the axes X and Z and by the axes Y and Z. The notions of upper, lower, front, rear, left and right parts are herein chosen arbitrarily for the requirements of the description. Similarly, the terms “distal” and “proximal” respectively qualify those elements or parts of elements that are located at a distance from or in proximity to the center (G).

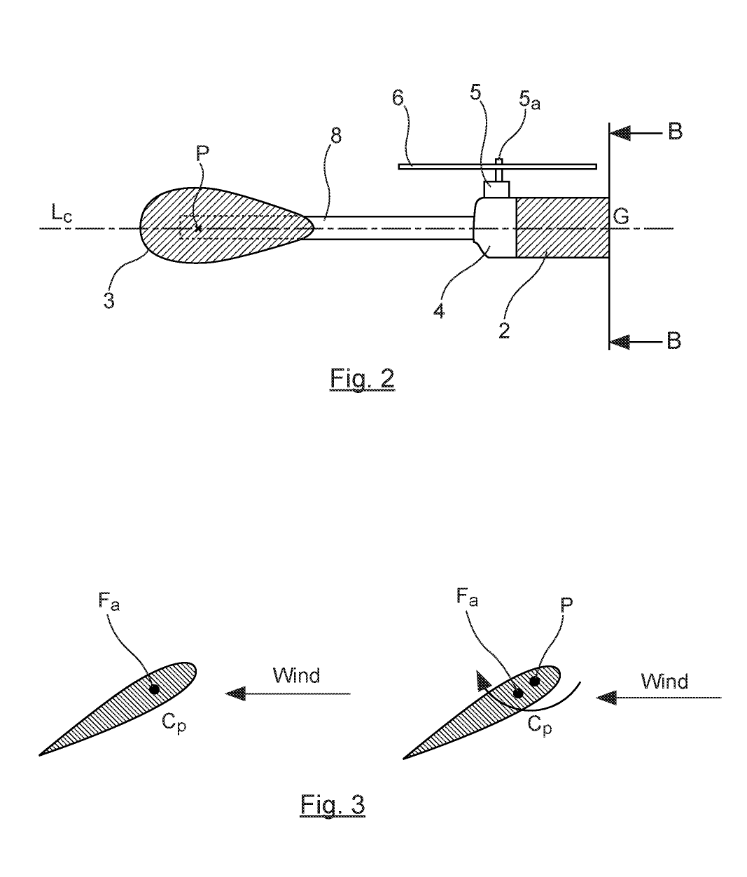

As illustrated by FIGS. 1 and 2, the hull (2) has a parallelepiped shape with a center (G). At each of its four corners, this hull (2) has a supporting arm (4) that extends in a substantially coplanar distal direction. Each of these supporting arms (4) comprises a rotor (5) on its upper face and in proximity to its distal extremity. The axis (5a) of this rotor (5) is oriented along the direction parallel to the axis Z. An airfoil surface (6) comprising a plurality of propellers, is arranged pivotingly about the axis (5a) of the rotor (5) along a plane substantially perpendicular to the axis Z. The assembly constituted by the rotor (5) and the airfoil surface (6) forms a propulsion device (7). Each propulsion device is actuated by means of a processing unit located in the hull (2) of the drone (1). The variations of the sense and speed of rotation of the four rotors (5), relative to each other, gives rise to roll, yaw and pitch motions of the drone (1), according to a control process known to those skilled in the art. Each of the distal extremities of the supporting arm (4) is fixedly attached to an attachment bar (8) which extends in a direction substantially parallel to the axis X. The four attachment bars (8) are fixedly attached in sets of two, at their proximal extremity, by means of two reinforcement bars or braces (9). A wing (3) and a wing (3) are respectively laid out in the front and rear of the drone (1) on either side of the hull (2). These wings (3) extend along directions parallel to the pitch axis Y between the distal extremities of the attachment bars (8). A pivoting link about a pivoting axis is obtained between each extremity of the wings (3) and the attachment<bars (8). The wings (3) are oriented about the pivoting axis so that the profile chord line plane of each of these wings is substantially parallel to the plane defined by the propulsion devices (7). The profile chord line plane is formed by the profile chord line (Lc) and the pivoting axis of the wing.

According to one embodiment of the disclosure, the travel of the wings (3) about their pivoting axis is symmetrical relative to the vertical, thus enabling the drone (1) to directly reverse its sense of movement without having to make a yaw rotation of 180°.

An orientation control device, such as a servo-mechanism, mounted between the distal extremity of the reinforcement bar (9) and the pivoting axis of a wing (3) enables the automatic control of the orientation of the wing (3) at a determined value. The orientation control device is itself controlled by the processing unit of the drone.

According to another embodiment of the disclosure, this automatic control can be effected through other types of actuation that may be either directly mounted or situated at a distance (and carried out by transmission).

The frame (10) of the drone corresponds to the assembly formed by the hull (2), the supporting arm (4), the attachment bars (8) and the reinforcement bars (9) of the drone (1).

### 5.3. Variations in the Orientation of a Wing of a Drone According to One Particular Embodiment of the Disclosure

FIG. 3 gives an illustration in greater detail of the possible variations in the orientation of a wing (3) of a drone (1). For reasons of clarity, the wing (3) is shown in a profile view that corresponds to a plane parallel to the median plane of the drone (1), perpendicular to the pivoting axis of the wing (3) at a pivot point (P). The wing (3) is considered in the framework of a direct terrestrial referential system (P; X′; Y′; Z′) centered at (P). The axes X′ and Y′ are parallel to the ground. The axes Y′ and Y are parallel to each other. The axis Z′ is perpendicular to the ground. The attitude of the drone then corresponds to the angle formed between the axes X and X′. The tilt of the wing (3) corresponds to the angular distance from the profile chord line (LC) to the axis X. The angle of attack (α) of the wing (3) corresponds to the angle formed between the direction of the air and the profile chord line (Lc). Assuming that the direction of the air is parallel to the axis X′, especially in fast flight, it is deduced that the angle of attack (α) corresponds to the angle formed between the profile chord line (Lc) of the wing (3) and the axis X′.

When a wing (3) is placed in an air flow, the resultant of the aerodynamic forces (Fa) gets applied at a point (Cp) called a “center of pressure” or aerodynamic center (see the left-hand part of FIG. 3). For a symmetrical profile, the location of this point (Cp) varies little according to the angle of attack (α). It is situated along the axis of symmetry at about a quarter of the chord line from the driving edge. When the pivoting point (P) of the wing is situated to the front of this point (Cp) the aerodynamic force (Fa) generates torque which tends to align the wing (3) windwards. This is the principle of the wind vane. In other words, the angle of attack (α) of the wing (3) tends towards a zero value whatever the wind conditions. This value is not satisfactory in itself because a zero angle of attack gives zero lift. However, it is situated close to the values of angles of attack that are promising from an energy point of view (they are small angles of attack (α)). Naturally, the principle presented here above is valid for the entire wing; when the pivoting axis of the wing is situated in front of the axis of the pressure point (or the axis of the center of pressure) (the axis that passes through the point (Cp) and is parallel to the pivoting axis), the aerodynamic force (Fa) generates a torque that tends to get aligned with the wing (3) facing the wind.

In the context of the stationary flight phase, or vertical flight phase, the drone (1) moves along a direction parallel to the axis Z′. The optimal value of the angle of attack (α) depends then on two constraints that are exerted in perpendicular directions, namely:
The constraint associated with the force of air resistance (FrZ) to the ascent of the drone (1) directed from the top to the bottom along the axis Z′. The value of this stress varies according to the speed of ascent of the drone and the apparent surface area of the upper part of the wing (3). The value of this surface area diminishes as the tilt of the wing varies from 0° to 90°, and vice versa;
The wind drag of the wing (3). This constraint, the corresponding force (Fv) of which is oriented along a horizontal axis, depends on the speed of the wind and the wind drag surface area of the wing. The value of this wind drag surface area depends on the tilt of the wing (3).

The respective values of the stresses (constraints) resulting from the action of the forces (FrZ) and (Fv) on the wing (3) therefore vary in an inversely proportional manner. The optimal value of the tilt of the wing therefore corresponds to a value of tilt for which the stress corresponding to the resultant of the sum of the forces (FrZ) and (Fv) has a minimum value.

In practice, assuming that the speed of the wind is great during the ascending phase of the drone, it is preferable to adopt a tilt value close to 0°, in order to limit the wind resistance of the wings and therefore the offset motions of the drone outside the axis Z′, which adversely affect its stability. It must be noted that such an optimizing of tilt of the drone is impossible in the context of a “tilt wing” type craft.

By contrast, assuming that the wind speed is negligible during the ascending phase of the drone, it is preferable to adopt a value of tilt close to 90°, in order to limit the resistance of the air to the ascent of the drone, and therefore to limit the energy needed to carry out this work. It must be noted that such an optimizing of tilt of the wing of the drone is impossible in a “tilt-rotor” type craft. According to one embodiment of the disclosure, the wings (3) are capable of being disengaged from the frame (10) of the drone so that their orientation can be passively adapted to the stresses exerted on them.

In the context of the fast flight phase, or horizontal flight phase, the drone (1) moves in a direction parallel to the axis X′. The optimal value of the angle of attack then does not depend on only one stress associated with the force of resistance of air (FrX) to the horizontal movement of the drone (1) directed along the axis X′. As mentioned here above, the values of angle of attack that can maximize the energy autonomy of the drone are then close to 0°. The pivoting of the wings (3) relative to the rest of the drone (1) therefore increases the lift of the wings and therefore improves the energy autonomy of the drone throughout the phases of flight independently of the attitude of the drone and of the orientation of its rotors.

It must be noted that the problems and issues linked, in fast flight, to non-dependency between the orientation of the wings and the attitude of the drone do not arise in the context of tilt-rotor and tilt-wing craft, since the orientation of the frame is constantly parallel to the ground in these cases.

The variations of the angles of attack of the wings also give the drone (1) better maneuverability, since the fast changes of lift have a direct influence on the movements made by the drone. In this respect and according to one particular embodiment of the disclosure, the user can bring about variations in the angle of attack of the wings for purposes of maneuverability. Such an approach then prevails over methods for controlling the tilt of the wings aimed at reducing energy consumption.

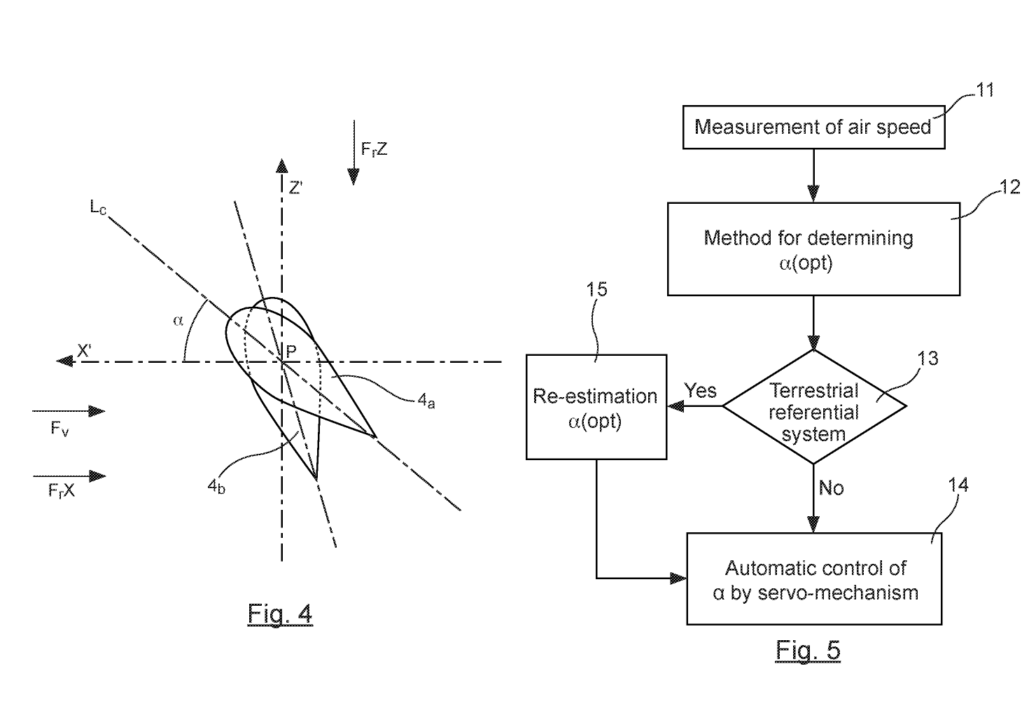

According to one particular embodiment and as illustrated in FIG. 4, one and the same wing (3) comprises a plurality of parts (4a, 4b) that are pivotingly mobile relative to each other along an axis parallel to the pitch axis Y of the drone. The fact that these different parts of the same wing (3) are not fixedly coupled to each other then appreciably improves the maneuverability of the drone (1) and especially its roll capacity.

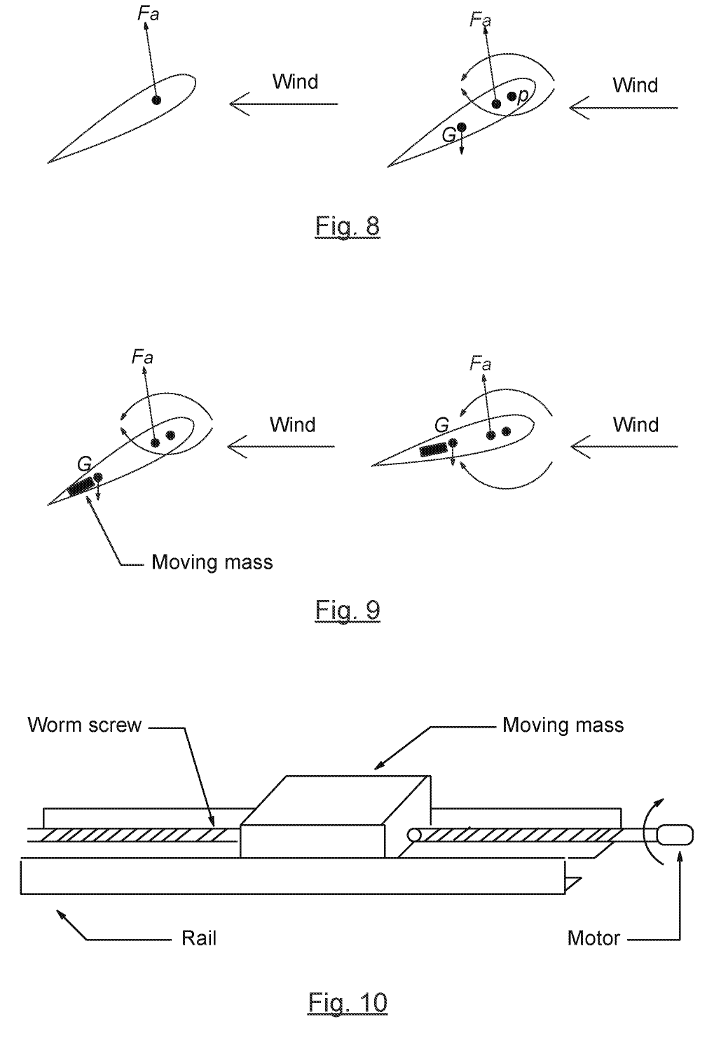

In a complementary way, it can be specified that the off-centering of the pivoting axis (which passes through the point P in FIG. 3) acts in such a way that the wing tilts naturally windward, creating a torque that tends to bring the angle of attack to a value of equilibrium equal to zero. Because of the torque generated by the force of gravity (which is applied to the center of mass G in FIG. 8), this value of equilibrium can be different from zero. Indeed, when there are no externally controlled torque values, this value of equilibrium will result from the equilibrium between the torque generated by the aerodynamic forces and the torque generated by the gravitational forces. It is worthwhile situating the center of mass in the rear of behind the pivoting axis (P) in order to create a positive angle of attack (close to 90°) for the small values of air speed; this angle of attack then tends to get reduced naturally when the air speed increases, and therefore tends to provide greater lift to the wing.

On the basis of this principle of equilibrium, and in order to provide a means of permanent control of the angle of attack, in one particular embodiment, the wing is provided with a moving mass system. Such a system modifies the position of the center of mass (point G) and therefore, according to the principle mentioned here above and illustrated in FIG. 9, controls the value of the angle of attack in a simple and efficient manner: the moving mass, moving perpendicularly to the pivoting axis, modifies the center of mass in a simple way whatever the air flow (i.e. whatever the air speed).

One particular embodiment of this moving mass system is represented in FIG. 10. The moving mass, situated between two rails, slides along a worm screw. An actuator controls the rotation of the worm screw and therefore controls the position of the moving mass. This system has the value of being transparent from an energy viewpoint in established flight: no energy is needed to keep the moving mass in a fixed position because the mass does not move by itself: the worm screw maintains the position of the mass. It is therefore particularly interesting from the viewpoint of the present invention which is aimed precisely at providing increased stability and setting limits on energy consumption.

### 5.4. Method for Controlling the Orientation of a Drone Wing According to One Particular Embodiment of the Disclosure

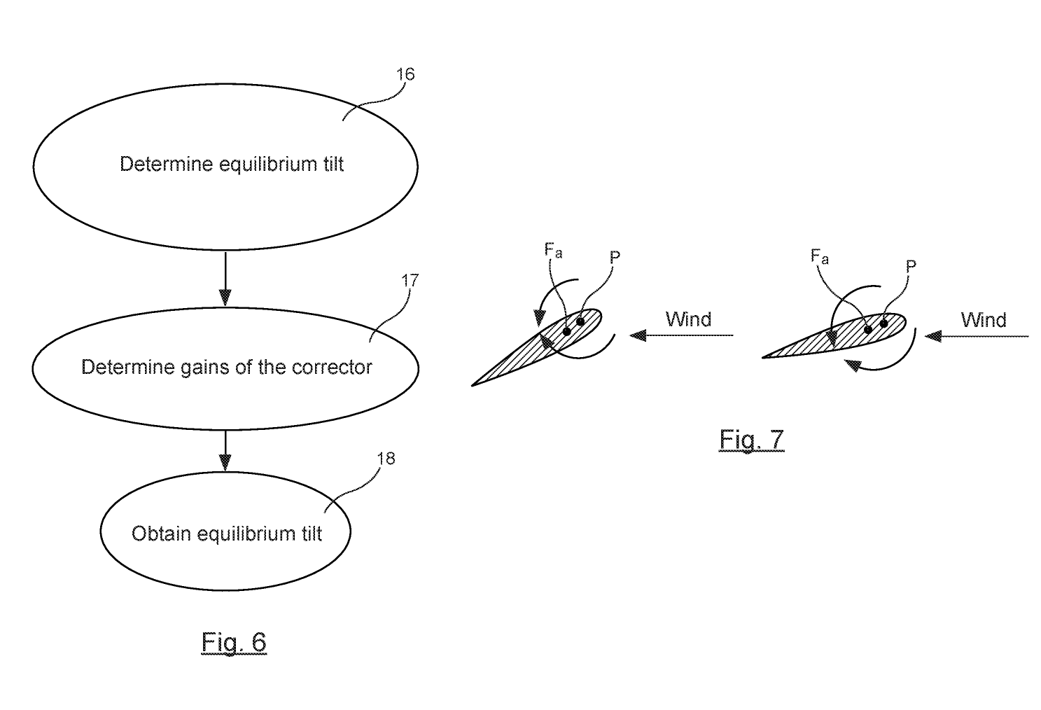

FIGS. 5 and 6 illustrate different methods for controlling the orientation of wing of a drone according to embodiments of the disclosure used to obtain efficient flight from the energy viewpoint and offering good resistance to wind.

Such methods are for example obtained by using the methods available in the prior art for rotating wing structures for the computation of energy consumption as well as classic methods related to aerodynamic lift and drag proper to propellers and wings. Starting from this knowledge of the “optimal” tilt of the wing, the problem is that of defining control methods that can automatically link the tilt of the wing to this optimal tilt.

These control methods implement at least one flight parameter of the drone. The flight parameter of the drone comprises especially the ground speed of the drone and the angular tilt of the wing relative to the frame (10) of the drone.

The choice of one method rather than another depends especially on the sensors and actuators available on the drone (1) and on the ground.

According to one first embodiment of the disclosure, illustrated in FIG. 5, one method of control makes the tilt of the wing vary as a function of the air speed.

On the assumption that the drone (1) is equipped with sensors such as wind speed indicators or pitot tubes to measure the air speed of the drone (1), the direct measurement of air speed (11) and the model of optimal tilt of the wings as a function of the air speed directly give the optimal tilt to be attained (12).

If this optimal tilt is expressed relative to the frame (10) of the drone (13) (for example the tilt of the wings (3) relative to the plane of the propellers (6)), the orientation controlling device enables the automatic linking of the tilt of the wing to the optimal value. If the optimal tilt is expressed relative to a terrestrial referential system<(for example (P; X′; Y′; Z′)) (14), then this fact can be expressed again in relation to the frame (10) of the drone in using the estimation of the attitude of the drone (15) needed for the steering of the craft.

Assuming that the air speed is measured on the ground through a GPS sensor for example, it is considered for purposes of simplicity that the wind is negligible. The ground speed is then equal to the air speed and the method described here above can be applied. In practice, with such a method, good results are obtained when the wind is effectively negligible but performance deteriorates in the case of significant wind.

According to a second embodiment of the disclosure, illustrated in FIG. 6, one control method enables the control of the tilt of the wing according to the torque exerted by the air on the wing. Such a method does not require any measurement of speed. This approach can be used when there is no speed sensor available or when the upper-air conditions are such that the air speed cannot be estimated satisfactorily. Assuming that the points (P) and (Cp) are positioned as are described in the part 5.3, the principle of this method relies on the implementing of a variable-gain recoil spring (or proportional-derivative) type controller.

First of all, using an actuator, a control torque is applied. This torque acts in a sense opposite that of the torque generated by the aerodynamic forces (see left-hand part of FIG. 7). This torque, which is zero when the wing points upwards, increases when the wing tilts to the horizontal. For a certain value of tilt of the wing, the two torque values compensate for each other to give the equilibrium tilt (16) (see right-hand part of FIG. 7). For this equilibrium to be stable, a control term expressed in terms of speed of tilt of the wing, needs to be added to the compensator (thus a recoil-spring type of “proportional-derivative” type controller is obtained). The gains of the compensator (the gain of the proportional term) determine the tilt of equilibrium. These gains are therefore chosen (17) in such a way that this position is as close as possible to the optimal tilt given by the model. Since the aerodynamic forces are proportional to the square of the speed, the “rigor” of the controller can be made to vary according to the tilt of the wing. Thus, without knowledge of the air speed, the wing naturally takes (18) a tilt that is efficient from the energy viewpoint (with an angle of attack that is all the smaller as the air speed is great).

1. A light unmanned vertical take-off aircraft comprising:
a frame;
at least two fixed coplanar propulsion devices; and
at least one wing providing lift for said aircraft and having a profile chord line, said coplanar propulsion devices and said wing being each laid out on the frame of said aircraft such that a plane of the profile chord line of said wing is substantially parallel to a plane defined by said at least two coplanar propulsion devices, wherein said at least one wing is pivotingly mobile relative to said frame along a pivoting axis parallel to a pitch axis of said aircraft, the pivoting axis of the wing being situated in front of an axis substantially parallel to the pivoting axis and being called an axis of the pressure point.

2. The light unmanned vertical take-off aircraft according to claim 1, further comprising four coplanar propulsion devices.

3. The light unmanned vertical take-off aircraft according to claim 1, wherein each of the at least two coplanar propulsion devices comprises a rotor and an airfoil surface in rotation around an axis of said rotor.

4. The light unmanned vertical take-off aircraft according to claim 1, wherein said at least one wing is mobile between at least two positions:
a position in which the lift of the wing has no influence on flight dynamics of the aircraft;
a position in which the lift of the wing influences the flight dynamics of the aircraft.

5. The light unmanned vertical take-off aircraft according to claim 1, an orientation of said at least one wing relative to the frame is a function of at least one flight parameter of the aircraft.

6. The light unmanned vertical take-off aircraft according to claim 1, comprising at least two wings.

7. The light unmanned vertical take-off aircraft according to claim 6, wherein said wings are laid out symmetrically on said frame, on either side of a plane parallel to said pitch axis, said plane parallel to said pitch axis including the center of gravity of said aircraft.

8. The light unmanned vertical take-off aircraft according to claim 6, wherein at least one of said wings comprises a plurality of parts pivotingly movable relative to one another along an axis parallel to the pitch axis of said aircraft.

9. The light unmanned vertical take-off aircraft according to claim 1, wherein said at least one wing is positioned detachably on said frame.

10. A method comprising:
flying a light unmanned vertical take-off aircraft comprising:
a frame;
at least two fixed coplanar propulsion devices; and
at least one wing providing lift for said aircraft and having a profile chord line, said coplanar propulsion devices and said wing being each laid out on the frame of said aircraft such that a plane of the profile chord line of said wing is substantially parallel to a plane defined by said at least two coplanar propulsion devices, wherein said at least one wing is pivotingly mobile relative to said frame along a pivoting axis parallel to a pitch axis of said aircraft, the pivoting axis of the wing being situated in front of an axis substantially parallel to the pivoting axis and being called an axis of the pressure point; and
controlling an orientation of the wing as a function of at least one flight parameter of the aircraft.
